(19) United States
(12) Patent Application Publication
(10) Pub. No.: US 2022/0243340 A1
(43) Pub. Date: Aug. 4, 2022

(54) A SYSTEM AND A METHOD FOR AN ELECTROCHEMICAL PROCESS

(71) Applicant: LAPPEENRANNAN-LAHDEN TEKNILLINEN YLIOPISTO LUT, Lappeenranta (FI)

(72) Inventors: Joonas KOPONEN, Lappeenranta (FI); Vesa RUUSKANEN, Lappeenranta (FI); Antti KOSONEN, Lappeenranta (FI); Anton KRIMER, Lappeenranta (FI); Jero AHOLA, Lappeenranta (FI); Markku NIEMELÄ, Lappeenranta (FI)

(21) Appl. No.: 17/761,437

(22) PCT Filed: Jun. 23, 2020
(86) PCT No.: PCT/FI2020/050445

§ 371 Date: Mar. 17, 2022

(30) Foreign Application Priority Data
Sep. 19, 2019 (FI) 20195786

(51) Int. Cl. C25B 9/65; C25B 1/04; B01D 61/46; B01D 61/42; B01D 61/52; C25B 13/00; C25B 9/17; C25B 11/00

(52) U.S. Cl. CPC C25B 9/65; C25B 1/04; B01D 61/46; B01D 61/422; H02M 7/162; C25B 13/00; C25B 9/17; C25B 11/00; B01D 61/52

(57) ABSTRACT

A system for an electrochemical process includes an electrochemical reactor, a converter bridge for supplying direct current to electrodes of the electrochemical reactor, and serial inductors connected to alternating voltage terminals of the converter bridge. The converter bridge includes bi-directional controllable switches between the alternating voltage terminals and direct voltage terminals of the converter bridge. Forced commutation of the bi-directional controllable switches enables reduction of current ripple in the direct current supplied to the electrochemical reactor. The forced commutation enables also to control a power factor of an alternating voltage supply of the system.

### FIELD OF THE DISCLOSURE

The disclosure relates to a system for an electrochemical process such as e.g. electrolysis or electrodialysis. Furthermore, the disclosure relates to a method for supplying electric power to an electrochemical process.

### BACKGROUND

An electrochemical process where electric power is supplied to process fluid can be for example an electrolysis process or an electrodialysis process. The electrolysis can be e.g. water electrolysis for decomposing water into hydrogen gas H₂ and oxygen gas O₂. A widely used type of water electrolysis is alkaline water electrolysis where electrodes operate in alkaline liquid electrolyte that may comprise e.g. aqueous potassium hydroxide “KOH” or aqueous sodium hydroxide “NaOH”. The electrodes are separated by a porous diaphragm that is non-conductive to electrons, thus avoiding electrical shorts between the electrodes. The porous diaphragm further avoids a mixing of produced hydrogen gas H₂ and oxygen gas O₂. The ionic conductivity needed for electrolysis is caused by hydroxide ions OH— which are able to penetrate the porous diaphragm. The electrodialysis is typically used to desalinate saline solutions but other applications such as treatment of industrial effluents, demineralization of whey, and deacidification of fruit juices are becoming increasingly important. The electrodialysis is carried out in an electrodialysis stack that is between electrodes and comprises an alternating series of anion-selective membranes and cation-selective membranes. Areas between successive ones of the anion- and cation-selective membranes constitute dilute compartments and concentrate compartments. Electric field moves cations through the cation-selective membranes and anions through the anion-selective membranes. The net result is that ion concentration in the dilute compartments is reduced, and the adjacent concentrate compartments are enriched with ions.

An electrochemical process of the kind described above requires direct current “DC” power. Thus, conversion from alternating current “AC” to direct current “DC” i.e. rectification is needed in a system connected to an alternating voltage network. Power electronics plays a key role in implementation of a controlled DC power supply. In industrial electrolysis and electrodialysis systems, rectifiers based on thyristors are a common choice. More detailed information is presented e.g. in the publication: J. R. Rodriguez, J. Pontt, C. Silva, E. P. Wiechmann, P. W. Hammond, F. W. Santucci, R. Alvarez, R. Musalem, S. Kouro, P. Lezana: Large current rectifiers, State of the art and future trends, IEEE Transactions, on Industrial Electronics 52, 2005, pp 738-746. The wide use of thyristor rectifiers in industrial systems is accomplished by the high efficiency, high reliability, and high current-handling capability of thyristors. Typical thyristor bridge rectifiers in industrial use are 6- and 12-pulse rectifiers. Direct voltage and direct current of a thyristor bridge rectifier have alternating components whose frequencies are multiples of the frequency of alternating supply voltage owing to natural commutation of the thyristors. In conjunction with a 50 Hz supply voltage, the main alternating components with a 6-pulse thyristor rectifier are 300 Hz, 600 Hz, and 900 Hz and, with a 12-pulse thyristor rectifier, corresponding to the doubled number of switches, 600 Hz, 1200 Hz, and 1800 Hz, but lower in amplitude.

Resistive power loss in an electrical conductor is directly proportional to the square of electric current. Accordingly, an instantaneous increase in electric current strongly contributes to resistive power loss because of the quadratic relationship between the electric current and the resistive power loss. The greater a current ripple in direct current, the greater a difference between the root mean square “RMS” value and the mean value of the direct current. Therefore, the current ripple should be minimized to reduce losses in a system carrying out an electrochemical process of the kind described above. Furthermore, the current ripple imposes a dynamic operation on a millisecond time scale for the electrochemical process, which may accelerate degradation of an electrolysis or electrodialysis cell. For example, cathode degradation has been stated to occur in alkaline water electrolysis when cell voltage drops below a certain protective value. More detailed information is presented e.g. in the publication: A. Ursúa, E. L. Barrios, J. Pascual, I. S. Martin, P. Sanchis: Integration of commercial alkaline water electrolysers with renewable energies, Limitations and improvements, International Journal of Hydrogen Energy, 41, 30, 2016, pp. 12852-12861. In cases where current ripple causes instantaneous current density to approach zero or even to get zero, a safe operating range of a water electrolysis system gets limited due to non-optimal quality of supplied direct current because the Faraday efficiency decreases and amount of hydrogen gas on the oxygen side increases at smaller current densities. Therefore, better quality of the supplied direct current broadens the safe operating range as well as an energy efficient operating range.

### SUMMARY

The following presents a simplified summary in order to provide a basic understanding of some aspects of various embodiments. The summary is not an extensive overview of the invention. It is neither intended to identify key or critical elements of the invention nor to delineate the scope of the invention. The following summary merely presents some concepts in a simplified form as a prelude to a more detailed description of exemplifying and non-limiting embodiments.

In accordance with the invention, there is provided a new system for an electrochemical process that can be for example an electrolysis process or an electrodialysis process. A system according to the invention comprises:
an electrochemical reactor for containing fluid and comprising electrodes for directing electric current to the fluid,
a converter bridge having alternating voltage terminals for receiving one or more alternating voltages and direct voltage terminals for supplying direct current to the electrodes of the electrochemical reactor, and
serial inductors connected to the alternating voltage terminals of the converter bridge,

The above-mentioned converter bridge comprises converter legs each comprising one of the alternating voltage terminals and being connected between the direct voltage terminals. Each of the converter legs comprises a bi-directional upper-branch controllable switch between the alternating voltage terminal of the converter leg under consideration and a positive one of the direct voltage terminals and a bi-directional lower-branch controllable switch between the alternating voltage terminal of the converter leg under consideration and a negative one of the direct voltage terminals.

Forced commutation of the bi-directional controllable switches of the converter bridge enables reduction of current ripple in the direct current supplied to the electrodes of the electrochemical reactor. Furthermore, the forced commutation of the bi-directional controllable switches enables to control the power factor of an alternating voltage supply of the system.

In accordance with the invention, there is provided also a new method for supplying electric power to an electrochemical process. A method according to the invention comprises:
supplying one or more alternating voltages via serial inductors to alternating voltage terminals of a converter bridge of the kind described above, and
supplying direct current from direct voltage terminals of the converter bridge to electrodes of an electrochemical reactor to carry out the electrochemical process.

Exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments and their advantages are explained in greater detail below in the sense of examples and with reference to the accompanying drawings, in which:

FIG. 1 illustrates a system according to an exemplifying and non-limiting embodiment for an electrochemical process,

FIG. 2 illustrates a system according to another exemplifying and non-limiting embodiment for an electrochemical process, and

FIG. 3 shows a flowchart of a method according to an exemplifying and non-limiting embodiment for supplying electric power to an electrochemical process.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

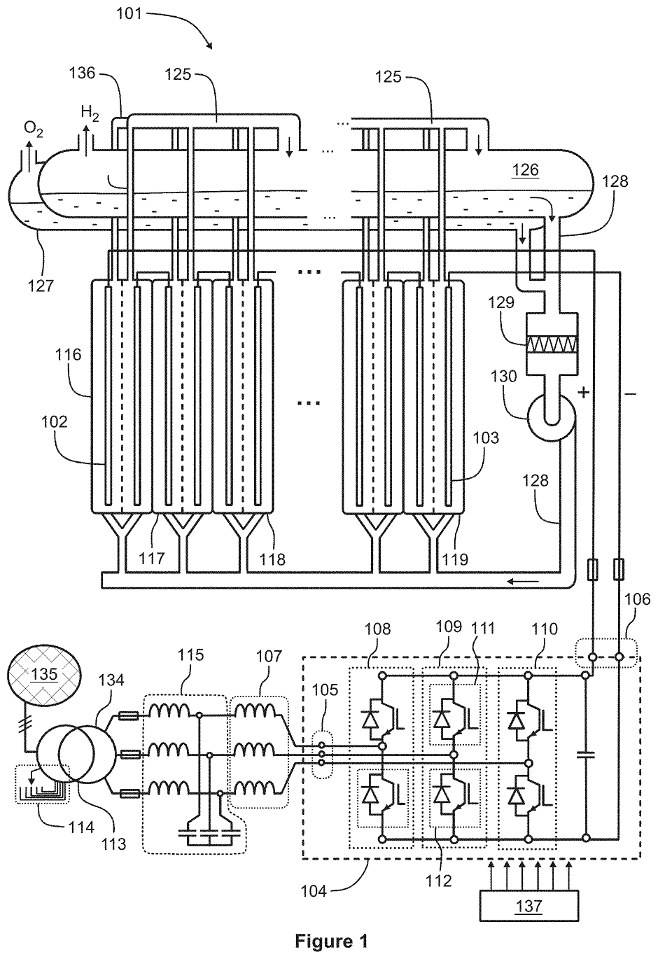

FIG. 1 illustrates a system according to an exemplifying and non-limiting embodiment for an electrochemical process. The system comprises an electrochemical reactor 101 for containing liquid and comprising electrodes for directing electric current to the liquid. In FIG. 1, two of the electrodes are denoted with references 102 and 103. In the exemplifying system illustrated in FIG. 1, the electrochemical reactor 101 comprises a stack of electrolysis cells. The electrolysis cells may contain for example alkaline liquid electrolyte for alkaline water electrolysis. In this exemplifying case, the liquid electrolyte may comprise for example aqueous potassium hydroxide “KOH” or aqueous sodium hydroxide “NaOH”. It is however also possible that the electrolysis cells contain some other electrolyte. In FIG. 1, four of the electrolysis cells are denoted with references 116, 117, 118, and 119. Each of the electrolytic cells comprises an anode, a cathode, and a porous diaphragm dividing the electrolysis cell into a cathode compartment containing the cathode and an anode compartment containing the anode. The system may comprise e.g. tens or even hundreds of electrolysis cells. It is however also possible that a system according to an exemplifying and non-limiting embodiment comprises from one to ten electrolysis cells. In the exemplifying system illustrated in FIG. 1, the electrolysis cells are electrically series connected. It is however also possible that electrolytic cells of a system according to an exemplifying and non-limiting embodiment are electrically parallel connected, or the electrolytic cells are arranged to constitute series connected groups of parallel connected electrolytic cells, or parallel connected groups of series connected electrolytic cells, or the electrolytic cells are electrically connected to each other in some other way.

The system comprises a hydrogen separator tank 126 and a first piping 125 from the cathode compartments of the electrolysis cells to an upper portion of the hydrogen separator tank 126. The system comprises an oxygen separator tank 127 and a second piping 136 from the anode compartments of the electrolysis cells to an upper portion of the oxygen separator tank 127. The system comprises a third piping 128 for circulating the liquid electrolyte from a lower portion of the hydrogen separator tank 126 and from a lower portion of the oxygen separator tank 127 back to the electrolysis cells. In the hydrogen and oxygen separator tanks 126 and 127, hydrogen and oxygen gases H₂ and O₂ are separated as gases continue to rise upwards and the liquid electrolyte returns to the electrolyte cycle. In the exemplifying system illustrated in FIG. 1, the third piping 128 comprises a controllable pump 130 for pumping the liquid electrolyte to the electrolysis cells. A pump-controlled electrolyte cycle is advantageous especially when temperature control is needed. It is however also possible that a system according to an exemplifying and non-limiting embodiment comprises a gravitational electrolyte circulation. In the exemplifying system illustrated in FIG. 1, the third piping 128 further comprises a filter 130 for filtering the liquid electrolyte. The filter 130 can be for example a membrane filter for removing impurities from the liquid electrolyte.

The system comprises a converter bridge 104 having alternating voltage terminals 105 for receiving alternating voltages and direct voltage terminals 106 for supplying direct current to the electrodes of the electrochemical reactor 101. The system comprises serial inductors 107 connected to the alternating voltage terminals of the converter bridge 104. The converter bridge 104 comprises converter legs 108, 109, and 110 each of which comprises one of the alternating voltage terminals 105 and is connected between the direct voltage terminals 106. Each of the converter legs comprises a bi-directional upper-branch controllable switch between the alternating voltage terminal of the converter leg under consideration and a positive one of the direct voltage terminals 106 and a bi-directional lower-branch controllable switch between the alternating voltage terminal of the converter leg under consideration and a negative one of the direct voltage terminals 106. In FIG. 1, the bi-directional upper-branch controllable switch of the converter leg 109 is denoted with a reference 111 and the bi-directional lower-branch controllable switch of the converter leg 109 is denoted with a reference 112. In this exemplifying case, each bi-directional controllable switch comprises an insulated gate bipolar transistor “IGBT” and an antiparallel diode. It is however also possible that each bi-directional controllable switch comprises e.g. a gate turn-off thyristor “GTO”, or a metal oxide field effect transistor “MOSFET”, or some other suitable semiconductor switch in lieu of the IGBT. Forced commutation of the bi-directional switches of the converter bridge 104 enables reduction of current ripple in the direct current supplied to the electrodes of the electrochemical reactor 101. Furthermore, the forced commutation of the bi-directional switches enables to control the power factor of an alternating voltage supply of the system. The system comprises a gate-driver unit 137 for controlling the operation of the controllable switches so that desired direct current is supplied to the electrodes of the electrochemical reactor 101 and desired alternating voltage occurs at the alternating voltage terminals 105.

The exemplifying system illustrated in FIG. 1 comprises a transformer 113 for transferring electric power from an alternating voltage network 135 via the serial inductors 107 to the alternating voltage terminals 105 of the converter bridge. In this exemplifying case, the system further comprises an inductor-capacitor “LC” filter 115 so that the inductor-capacitor filter 115 and the serial inductors 107 constitute an inductor-capacitor-inductor “LCL” filter. The secondary windings 134 of the transformer are connected via the LCL filter to the alternating voltage terminals 105 of the converter bridge 104. The secondary voltage of the transformer 113 is advantageously selected to be so low that the converter bridge 104 can operate with a suitable duty cycle ratio of the controllable switches when the direct voltage of the direct voltage terminals 106 is in a range suitable for the electrochemical reactor 101. The conversion from the alternating voltage to direct voltage is done in a single-step, which typically leads to a voltage-boosting character for the converter bridge 104. The voltage-boosting character makes it possible that the direct voltage at the direct voltage terminals 106 is higher than a maximum of alternating line-to-line voltages supplied to the system. In a system according to an exemplifying and non-limiting embodiment, the transformer 113 comprises a tap-changer 114 for changing the transformation ratio of the transformer. The tap-changer 114 can be e.g. an on-load tap-changer that allows to change the transformation ration during loading. The arrangement comprising the serial inductors 107, the converter bridge 104, and possibly the LC filter 115 can be used as a DC-DC converter, too.

The system may further comprise a current sensor for measuring the direct current supplied to the electrochemical reactor 101 and/or a voltage sensor for measuring the direct voltage of the direct voltage terminals 106. The above-mentioned current sensor and voltage sensor are not shown in FIG. 1. The current sensor and/or the voltage sensor can be for example parts of a converter device comprising the converter bridge 104. For another example, the current sensor and/or the voltage sensor can be parts of the electrochemical reactor 101. An output signal of the current sensor and/or an output signal of the voltage sensor can be delivered to a controller that controls the gate-driver unit 137. The controller is not shown in FIG. 1.

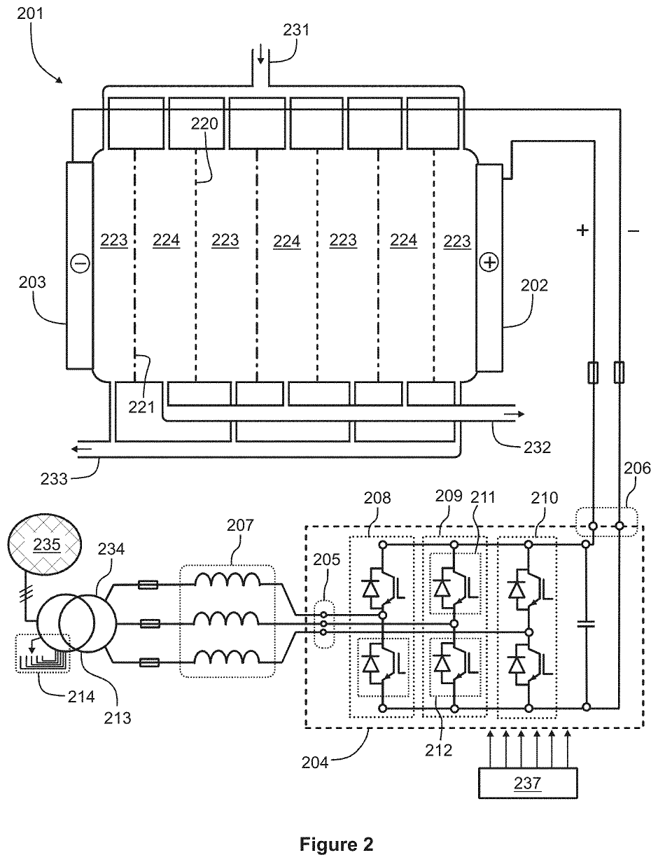

FIG. 2 illustrates a system according to an exemplifying and non-limiting embodiment for an electrochemical process. The system comprises an electrochemical reactor 201 for containing liquid and comprising electrodes 202 and 203 for directing electric current to the liquid. In the exemplifying system illustrated in FIG. 2, the electrochemical reactor 201 comprises an electrodialysis stack that is between the electrodes 202 and 203 and comprises an alternating series of anion-selective membranes and cation-selective membranes. In FIG. 2, one of the anion-selective membranes is denoted with a reference 220 and one of the cation-selective membranes is denoted with a reference 221. Areas between successive ones of the anion- and cation-selective membranes constitute dilute compartments 224 and concentrate compartments 223. Electric field moves cations through the cation-selective membranes and the anions through the anion-selective membranes. The net result is that ion concentration in the dilute compartments 224 is reduced, and the adjacent concentrate compartments 223 are enriched with the ions. In the exemplifying system illustrated in FIG. 2, the feed to be processed, e.g. saline feed, is received via an inlet 231, and the diluted liquid such as e.g. fresh water is removed via a first outlet 232, and the concentrate such as e.g. concentrated brine is removed via a second outlet 233.

The system comprises a converter bridge 204 having alternating voltage terminals 205 for receiving alternating voltages and direct voltage terminals 206 for supplying direct current to the electrodes 202 and 203 of the electrochemical reactor 201. The system comprises serial inductors 207 connected to the alternating voltage terminals 205 of the converter bridge 204. The converter bridge 204 comprises converter legs 208, 209, and 210 each of which comprises one of the alternating voltage terminals 205 and is connected between the direct voltage terminals 206. Each of the converter legs comprises a bi-directional upper-branch controllable switch between the alternating voltage terminal of the converter leg under consideration and a positive one of the direct voltage terminals and a bi-directional lower-branch controllable switch between the alternating voltage terminal of the converter leg under consideration and a negative one of the direct voltage terminals. In FIG. 2, the bi-directional upper-branch controllable switch of the converter leg 209 is denoted with a reference 211 and the bi-directional lower-branch controllable switch of the converter leg 209 is denoted with a reference 212. The system comprises a gate-driver unit 237 for controlling the operation of the controllable switches so that desired direct current is supplied to the electrodes of the electrochemical reactor 201 and desired alternating voltage occurs at the alternating voltage terminals 205.

The exemplifying system illustrated in FIG. 2 comprises a transformer 213 for transferring electric power from an alternating voltage network 235 via the serial inductors 207 to the alternating voltage terminals 205 of the converter bridge 204. In a system according to an exemplifying and non-limiting embodiment, the transformer 213 comprises a tap-changer 214, e.g. an on-load tap-changer, for changing the transformation ratio of the transformer.

The gate-driver unit 137 shown in FIG. 1, as well as the gate-driver unit 237 shown in FIG. 2, comprises driver circuits for controlling the controllable switches. Furthermore, the gate-driver unit 137 as well as the gate-driver unit 237 may comprise a processing system for running the driver circuits. The processing system may comprise one or more analogue circuits, one or more digital processing circuits, or a combination thereof. Each digital processing circuit can be a programmable processor circuit provided with appropriate software, a dedicated hardware processor such as for example an application specific integrated circuit “ASIC”, or a configurable hardware processor such as for example a field programmable gate array “FPGA”. Furthermore, the processing system may comprise one or more memory circuits each of which can be for example a Random-Access Memory “RAM” circuit.

It is to be noted that the invention is not limited to any specific electrolysis processes and/or any specific electrodialysis processes. For example, a system according to an exemplifying and non-limiting embodiment may comprise an electrochemical reactor for proton exchange membrane “PEM” water electrolysis, an electrochemical reactor for a solid oxide electrolyte cell “SOEC” process, or an electrochemical reactor for some other electrolysis process.

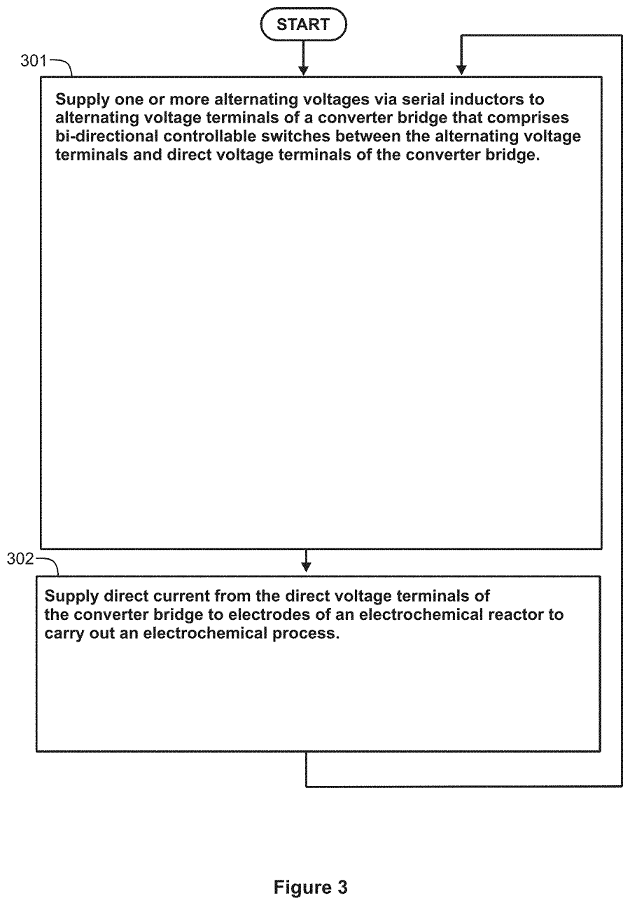

FIG. 3 shows a flowchart of a method according to an exemplifying and non-limiting embodiment for supplying electric power to an electrochemical process such as e.g. water electrolysis or electrodialysis. The method comprises the following actions:
action 301: supplying one or more alternating voltages via serial inductors to alternating voltage terminals of a converter bridge, and
action 302: supplying direct current from direct voltage terminals of the converter bridge to electrodes of an electrochemical reactor to carry out the electrochemical process,

wherein the converter bridge comprises converter legs each of which comprises one of the alternating voltage terminals and is connected between the direct voltage terminals. Each of the converter legs comprises a bi-directional upper-branch controllable switch between the alternating voltage terminal of the converter leg under consideration and a positive one of the direct voltage terminals, and a bi-directional lower-branch controllable switch between the alternating voltage terminal of the converter leg under consideration and a negative one of the direct voltage terminals.

A method according to an exemplifying and non-limiting embodiment comprises transferring, with a transformer, electric power from an alternating voltage network to the converter bridge so that secondary windings of the transformer are connected via the serial inductors to the alternating voltage terminals of the converter bridge.

A method according to an exemplifying and non-limiting embodiment comprises changing a transformation ratio of the transformer with a tap-changer.

In a method according to an exemplifying and non-limiting embodiment, the one or more alternating voltages are supplied to the alternating voltage terminals of the converter bridge via an inductor-capacitor filter that constitutes, together with the above-mentioned serial inductors, an inductor-capacitor-inductor filter.

In a method according to an exemplifying and non-limiting embodiment, the electrochemical process is an electrolysis process that can be for example an alkaline water electrolysis process, a proton exchange membrane “PEM” water electrolysis process, or a solid oxide electrolyte cell “SOEC” process.

In a method according to an exemplifying and non-limiting embodiment, the electrochemical process is an electrodialysis process such as e.g. desalination of water.

The specific examples provided in the description given above should not be construed as limiting the applicability and/or the interpretation of the appended claims. Lists and groups of examples provided in the description given above are not exhaustive unless otherwise explicitly stated.

1. A system for an electrochemical process, the system comprising:
an electrochemical reactor for containing fluid and comprising electrodes for directing electric current to the fluid,
a converter bridge having alternating voltage terminals for receiving one or more alternating voltages and direct voltage terminals for supplying direct current to the electrodes of the electrochemical reactor, and
serial inductors connected to the alternating voltage terminals of the converter bridge,
wherein the converter bridge comprises converter legs each comprising one of the alternating voltage terminals and being connected between the direct voltage terminals, each of the converter legs comprising a bi-directional upper-branch controllable switch between the alternating voltage terminal of the converter leg under consideration and a positive one of the direct voltage terminals, and a bi-directional lower-branch controllable switch between the alternating voltage terminal of the converter leg under consideration and a negative one of the direct voltage terminals.

2. A system according to claim 1, wherein the system comprises a transformer for transferring electric power from an alternating voltage network to the converter bridge, secondary windings of the transformer being connected via the serial inductors to the alternating voltage terminals of the converter bridge.

3. A system according to claim 2, wherein the transformer comprises a tap-changer for changing a transformation ratio of the transformer.

4. A system according to claim 1, wherein the system comprises an inductor-capacitor filter so that the inductor-capacitor filter and the serial inductors constitute an inductor-capacitor-inductor filter.

5. A system according to claim 1, wherein the electrochemical reactor comprises one or more electrolysis cells each comprising an anode, a cathode, and a porous diaphragm dividing the electrolysis cell into a cathode compartment containing the cathode and an anode compartment containing the anode.

6. A system according to claim 1, wherein the electrochemical reactor comprises an electrodialysis stack that is between the electrodes and comprises an alternating series of anion-selective membranes and cation-selective membranes.

7. A method for supplying electric power to an electrochemical process, the method comprising:
supplying one or more alternating voltages via serial inductors to alternating voltage terminals of a converter bridge, and
supplying direct current from direct voltage terminals of the converter bridge to electrodes of an electrochemical reactor to carry out the electrochemical process,
wherein the converter bridge comprises converter legs each comprising one of the alternating voltage terminals and being connected between the direct voltage terminals, each of the converter legs comprising a bi-directional upper-branch controllable switch between the alternating voltage terminal of the converter leg under consideration and a positive one of the direct voltage terminals, and a bi-directional lower-branch controllable switch between the alternating voltage terminal of the converter leg under consideration and a negative one of the direct voltage terminals.

8. A method according to claim 7, wherein the method comprises transferring, with a transformer, electric power from an alternating voltage network to the converter bridge, secondary windings of the transformer being connected via the serial inductors to the alternating voltage terminals of the converter bridge.

9. A method according to claim 8, wherein the method comprises changing a transformation ratio of the transformer with a tap-changer.

10. A method according to claim 7, wherein the one or more alternating voltages are supplied to the alternating voltage terminals of the converter bridge via an inductor-capacitor filter (115) that constitutes, together with the serial inductors, an inductor-capacitor-inductor filter.

11. A method according to claim 7, wherein the electrochemical process is an electrolysis process.

12. A method according to claim 11, wherein the electrolysis process is an alkaline water electrolysis process, a proton exchange membrane water electrolysis process, or a solid oxide electrolyte cell process.

13. A method according to claim 7, wherein the electrochemical process is an electrodialysis process.

14. A system according to claim 2, wherein the system comprises an inductor-capacitor filter so that the inductor-capacitor filter and the serial inductors constitute an inductor-capacitor-inductor filter.

15. A system according to claim 2, wherein the electrochemical reactor comprises one or more electrolysis cells each comprising an anode, a cathode, and a porous diaphragm dividing the electrolysis cell into a cathode compartment containing the cathode and an anode compartment containing the anode.

16. A system according to claim 2, wherein the electrochemical reactor comprises an electrodialysis stack that is between the electrodes and comprises an alternating series of anion-selective membranes and cation-selective membranes.

17. A system according to claim 3, wherein the system comprises an inductor-capacitor filter so that the inductor-capacitor filter and the serial inductors constitute an inductor-capacitor-inductor filter.

18. A system according to claim 3, wherein the electrochemical reactor comprises one or more electrolysis cells each comprising an anode, a cathode, and a porous diaphragm dividing the electrolysis cell into a cathode compartment containing the cathode and an anode compartment containing the anode.

19. A system according to claim 3, wherein the electrochemical reactor comprises an electrodialysis stack that is between the electrodes and comprises an alternating series of anion-selective membranes and cation-selective membranes.

20. A system according to claim 4, wherein the electrochemical reactor comprises one or more electrolysis cells each comprising an anode, a cathode, and a porous diaphragm dividing the electrolysis cell into a cathode compartment containing the cathode and an anode compartment containing the anode.
